(19) United States
(12) Patent Application Publication
(10) Pub. No.: US 2012/0073304 A1
(43) Pub. Date: Mar. 29, 2012

(54) TURBOMACHINE INCLUDING A CERAMIC MATRIX COMPOSITE (CMC) BRIDGE

(75) Inventors: Jeffrey John Butkiewicz, Greenville, SC (US); Andres Jose Garcia-Crespo, Greenville, SC (US); Stanley Frank Simpson, Simpsonville, SC (US)

(73) Assignee: General Electric Company, Schenectady, NY (US)

(21) Appl. No.: 12/889,860

(22) Filed: Sep. 24, 2010

(51) Int. Cl. F02C 1/00

(52) U.S. Cl. 60/772; 60/722

(57) ABSTRACT

A turbomachine includes a turbine section including a turbine inlet. A transition piece includes a transition piece inlet and a transition piece outlet. A ceramic matrix composite (CMC) bridge member links the transition piece outlet and the turbine inlet.

### BACKGROUND OF THE INVENTION

The subject matter disclosed herein relates to the art of turbomachines and, more particularly, to a ceramic matrix composite (CMC) bridge that joins a transition piece with a turbine section of a turbomachine.

In general, gas turbomachine engines combust a fuel/air mixture that releases heat energy to form a high temperature gas stream. The high temperature gas stream is channeled to a turbine section via a hot gas path. The turbine section converts thermal energy from the high temperature gas stream to mechanical energy that rotates a turbine shaft. The turbine section may be employed in a variety of applications, such as for providing power to a pump or an electrical generator.

Many gas turbomachines include an annular combustor within which are formed combustion gases that create the high temperature gas stream. Other turbomachines employ a plurality of combustors arranged in a can-annular array. In such a turbomachine, the hot gas path includes a transition piece that links a group of combustors with a first stage of the turbine section. The combustion gases formed in the group of combustors are delivered to the turbine section through the transition piece.

### BRIEF DESCRIPTION OF THE INVENTION

According to one aspect of the invention, a turbomachine includes a turbine section including a turbine inlet. A transition piece includes a transition piece inlet and a transition piece outlet. A ceramic matrix composite (CMC) bridge member links the transition piece outlet and the turbine inlet.

According to another aspect of the invention, a method of delivering combustion gases from a turbomachine combustor to a turbine section of a turbomachine includes producing combustion gases in the turbomachine combustor, directing the combustion gases into a transition piece, guiding the combustion gases along a ceramic matrix composite (CMC) bridge member linking the transition piece and the turbine section, and passing the combustion gases from the CMC bridge member into the turbine section.

According to yet another aspect of the invention, a turbomachine component includes a ceramic matrix composite (CMC) bridge member configured and disposed to link a transition piece and a turbine section of a turbomachine.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of a turbomachine including a composite matrix material (CMC) bridge including first and second CMC bridge members sealing an interface between a transition piece and a turbine section in accordance with an exemplary embodiment;

FIG. 2 is a lower right perspective view of the first CMC bridge member of FIG. 1;

FIG. 3 is a cross-sectional side view of a CMC bridge member in accordance with another aspect of the exemplary embodiment;

FIG. 4 is a cross-sectional side view of a CMC bridge member in accordance with still another aspect of the exemplary embodiment; and

FIG. 5 is a cross-sectional side view of a CMC bridge member in accordance with yet another aspect of the exemplary embodiment.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a turbomachine. The terms “radial” and “radially” as used in this application refer to directions and orientations extending substantially orthogonally to the center longitudinal axis of the turbomachine. The terms “upstream” and “downstream” as used in this application refer to directions and orientations relative to an axial flow direction with respect to the center longitudinal axis of the turbomachine.

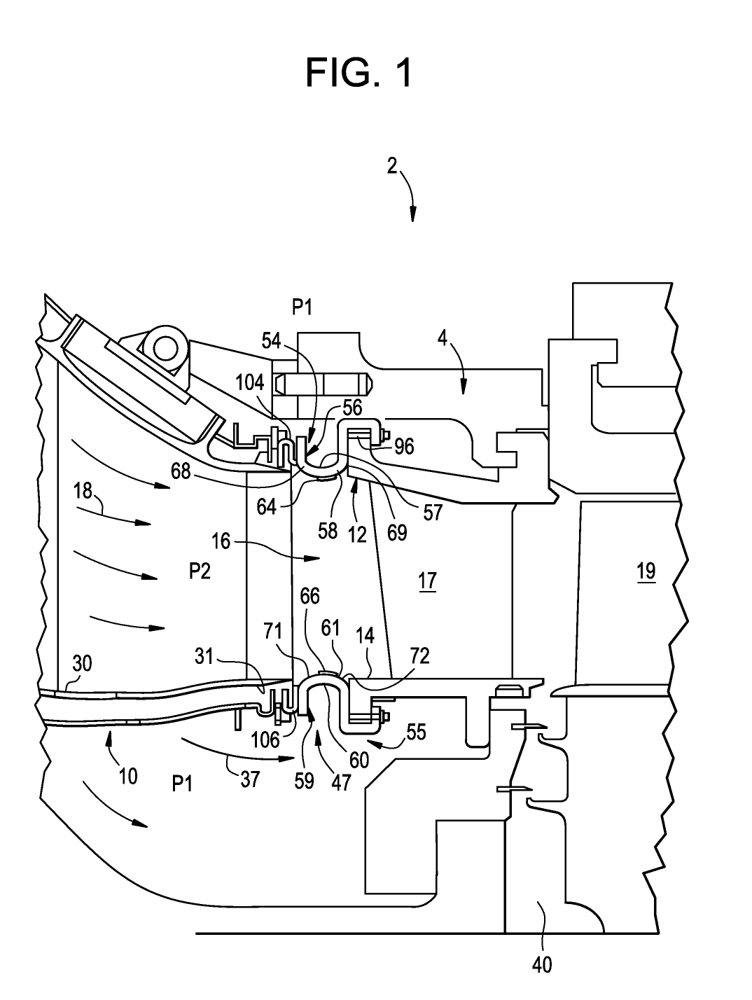

With reference to FIG. 1, a turbomachine constructed in accordance with an exemplary embodiment is indicated generally at 2. Turbomachine 2 includes a turbine section 4 that is fluidly linked to a combustor (not shown) through a transition piece 10. Turbine section 4 includes a turbine section inlet 12 defined by an end wall 14. A first stage 16 of turbine section 4 is arranged downstream from turbine section inlet 12. First stage 16 includes a plurality of vanes, one of which is indicated at 17, that guide combustion gases 18 to a plurality of first stage blades, one of which is indicated at 19. Combustion gases 18 flow axially into a transition piece inlet 30, pass through transition piece 10, and exit from a transition piece outlet 31 into turbine section inlet 12. At this point, combustion gases 18 pass over vanes 17 before acting upon blades 19. Blades 19 translate thermal and kinetic energy from combustion gases 18 into mechanical, rotational energy that is employed to rotate a shaft (not shown). In addition to combustion gases 18, compressor discharge air 37 passes from a compressor section (not shown) into a wheel space portion 40 of turbine section 4.

In accordance with an exemplary embodiment, turbomachine 2 includes a ceramic composite material (CMC) bridge 47 that links transition piece outlet 31 with turbine section inlet 12. In accordance with one aspect of the exemplary embodiment, CMC bridge 47 is formed from one or more of silicon carbide-silicon carbide (SiC—SiC) composites, oxide-oxide composites, and silicon nitride composites. Of course it should be understood that various other CMC materials may also be employed. CMC bridge 47 includes a first CMC bridge member 54 arranged at an outer interface between transition piece outlet 31 and turbine section inlet 12, and a second CMC bridge member 55 arranged at an inner interface between transition piece outlet 31 and turbine section inlet 12. First CMC bridge member 54 includes a main body 56 having an outer surface 57 and an inner surface 58. Likewise, second CMC bridge member 55 includes a main body 59 having an outer surface 60 and an inner surface 61.

First CMC bridge member 54 includes a flow guide 64 arranged on inner surface 58. Flow guide 64 directs combustion gases 18 away from end wall 14. Similarly, second CMC bridge member 55 includes a flow guide 66 arranged on inner surface 61. Flow guide 66 directs combustion gases 18 away from end wall 14 and/or disrupts crossflow vortex generation. With this arrangement, end wall 14 is protected from damage that may result from exposure to combustion gases 18. More specifically, combustion gases passing into an inlet portion 68 of CMC bridge member 54 pass over flow guide 64. Flow guide 64 directs combustion gases 18 through an outlet portion 69 of CMC bridge member 54 at trajectory that is angled away from end wall 14. Likewise, combustion gases passing into an inlet portion 71 of CMC bridge member 55 pass over flow guide 66. Flow guide 66 directs combustion gases 18 through an outlet portion 72 of CMC bridge member 55 at trajectory that is angled away from end wall 14.

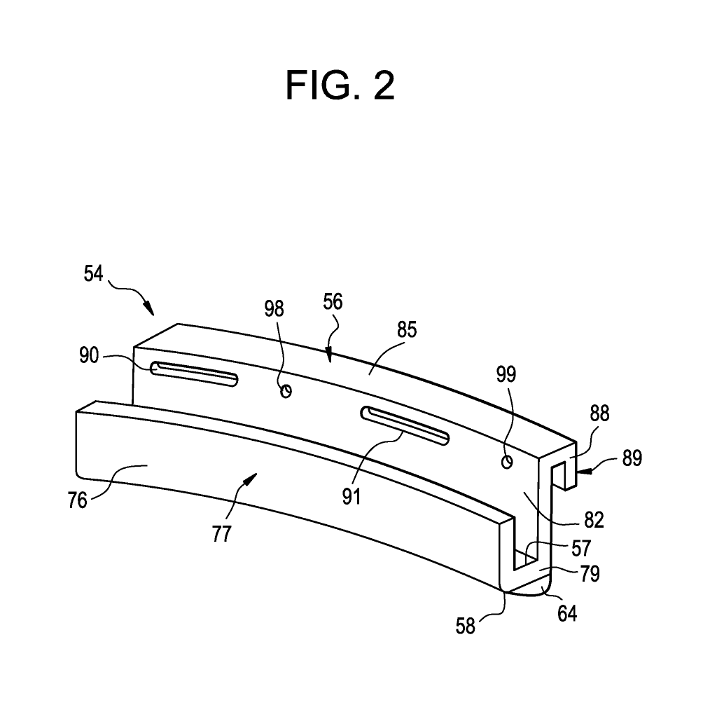

As best shown in FIG. 2, bridge member 54 includes a first section 76 that defines a first flange 77. First section 76 leads to a second section 79 that is substantially perpendicular to first section 76. A third section 82 extends from second section 79 and is substantially parallel to first section 76. A fourth section 85, that is substantially parallel to second section 79, extends from third section 82. A fifth section 88, that is substantially parallel to first and third sections 77 and 82, extends from fourth section 85. Third, fourth and fifth sections 82, 85, and 88 combine to define a second flange 89 that joins first CMC bridge member 54 to turbine section 4. In addition, bridge member 54 includes first and second mounting members 90 and 91 that are formed in second flange 89. Mechanical fasteners, one of which is indicated at 96 in FIG. 1, pass through mounting members 90, 91, and turbine section 4 to join first CMC bridge member 54 to turbine section 4. Second flange 89 also includes a plurality of mounting elements 98 and 99 that register with pins (not shown) to locate first CMC bridge member 54 on turbine section 4. Finally, turbomachine 2 is shown to include first and second flexible seals 104 and 106 that are configured to prevent combustion gases from leaking at an interface between transition piece outlet 31 and respective ones of inlet portions 68 and 71 of first and second CMC bridge member 54 and 55.

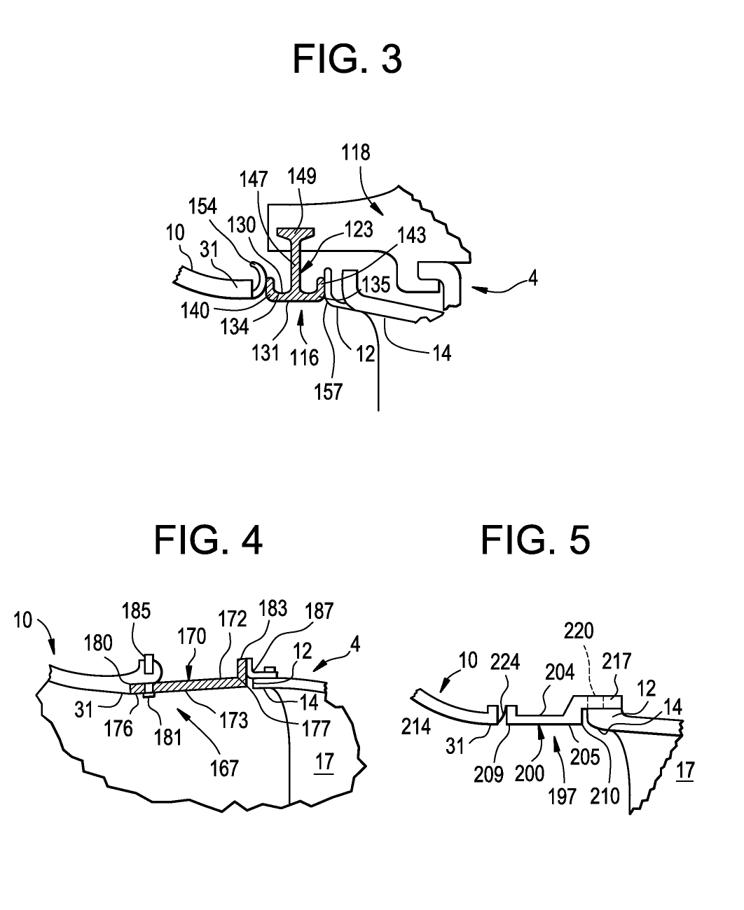

Reference will now be made to FIG. 3, wherein like reference numbers represent corresponding parts in the respective views, in describing a CMC bridge member 116 constructed in accordance with another exemplary embodiment. As will become more fully apparent below, CMC bridge member 116 is secured to turbine section 4 through a retaining ring 118 arranged at turbine section inlet 12. CMC bridge member 116 includes a main body 123 including an outer surface 130 and an inner surface 131 that defines an inlet portion 134 and an outlet portion 135. CMC bridge member 116 includes a first flange 140 arranged at inlet portion 134 and a second flange 143 arranged at outlet portion 135. A mounting member 147 extends substantially perpendicularly from outer surface 130. Mounting member 147 includes a dovetail section 149 that cooperates with corresponding structure (not separately labeled) on retaining ring 118 to secure CMC bridge member 116 to turbomachine 2. As further shown in FIG. 3, a first flexible seal 154 extends between inlet portion 134 and transition piece outlet 31 and a second flexible seal 157 extends between outlet portion 135 and turbine section inlet 12 to prevent compressor discharge air from bypassing the combustor and entering turbine inlet 12.

Reference will now be made to FIG. 4, wherein like reference numbers represent corresponding parts in the respective views, in describing a CMC bridge member 167 constructed in accordance with another exemplary embodiment. CMC bridge member 167 includes a main body 170 including an outer surface 172 and an inner surface 173 that defines an inlet portion 176 and an outlet portion 177. CMC bridge member 167 includes a first flange 180 arranged at inlet portion 176. First flange 180 is secured to transition piece outlet 31 through a mechanical fastener 181. CMC bridge 167 also includes a second flange 183 arranged at outlet portion 177. In the exemplary aspect shown, transition piece 10 includes an air channel 185 arranged at transition piece outlet 31. Air channel 185 directs a cooling fluid, for example compressor discharge air, onto first flange 180 to lower temperatures of CMC bridge member 167. As further shown in FIG. 4, a flexible seal 187 extends between outlet portion 177 and turbine section inlet 12 to prevent compressor discharge air from bypassing the combustor and entering turbine inlet 12.

Reference will now be made to FIG. 5, wherein like reference numbers represent corresponding parts in the respective views, in describing a CMC bridge member 197 constructed in accordance with another exemplary embodiment. CMC bridge member 197 includes a main body 200 including an outer surface 204 and an inner surface 205 that defines an inlet portion 209 and an outlet portion 210. CMC bridge member 197 includes a first flange 214 arranged at inlet portion 209 and a second flange 217 arranged at outlet portion 210. Second flange 217 is secured to turbine section inlet 12 through a mounting member 220. Mounting member 220 includes a sliding interface (not shown) that engages with corresponding structure on turbine section 4. CMC bridge 197 also includes a flexible seal 224 that extends between inlet portion 209 and transition piece outlet 31 to prevent compressor discharge air from bypassing the combustor and entering turbine inlet 12.

At this point it should be understood that the CMC bridge in accordance with exemplary embodiments provides a seal between the transition piece/turbine section interface in order to limit and/or prevent compressor discharge air from entering into the turbine inlet. The transition piece/turbine section interface is typically exposed to high temperatures and thus requires cooling in order to prolong component life. In contrast, the present invention provides a bridge formed from CMC materials that are able to withstand higher temperatures without degrading. By employing the CMC bridge in accordance with the exemplary embodiments the need for cooling airflow at the transition piece/turbine section interface is significantly reduced thereby enhancing turbomachine efficiency. The reduced cooling flow provides additional flow that can be used to extract work from the turbine.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a turbine section including a turbine inlet;
a transition piece including a transition piece inlet and a transition piece outlet; and
a ceramic matrix composite (CMC) bridge member linking the transition piece outlet and the turbine inlet.

2. The turbomachine according to claim 1, wherein the CMC bridge member includes an outer surface and an inner surface, the inner surface having a flow guide that directs combustion gases into the turbine inlet.

3. The turbomachine according to claim 2, wherein the flow guide is configured and disposed to direct combustion gases away from an end wall portion of the turbine inlet.

4. The turbomachine according to claim 1, wherein the CMC bridge member includes a main body having an inlet portion operatively connected to the transition piece and an outlet portion operatively connected to the turbine section.

5. The turbomachine according to claim 4, wherein the CMC bridge member includes a first flange extending about the inlet portion and a second flange extending about the outlet portion.

6. The turbomachine according to claim 5, wherein one of the first and second flanges is fastened to the corresponding one of the combustor and the turbine section.

7. The turbomachine according to claim 6, further comprising a seal member arranged between the other of the first and second flanges and the corresponding one of the transition piece and turbine section.

8. The turbomachine according to claim 5, wherein the CMC bridge member includes a mounting element projecting radially outward from the body between the first and second flanges.

9. The turbomachine according to claim 7, further comprising: a retaining ring operatively connected to the turbine section, the at least one bridge member being secured to the retaining ring through the mounting element.

10. The turbomachine according to claim 9, further comprising: a first seal member arranged between the first flange and the combustor and a second seal member arranged between the second flange and the turbine section.

11. The turbomachine according to claim 1, wherein the CMC bridge member is formed from one of a silicon carbide-silicon carbide (SiC—SiC) composite, oxide-oxide composite, and silicon nitride composite material.

12. The turbomachine according to claim 1, further comprising: an air channel arranged at the transition piece outlet, the air channel guiding a fluid flow onto the CMC bridge member.

13. A method of delivering combustion gases from a turbomachine combustor to a turbine section of a turbomachine, the method comprising:
producing combustion gases in the turbomachine combustor;
directing the combustion gases into a transition piece;
guiding the combustion gases along a ceramic matrix composite (CMC) bridge member linking the transition piece and the turbine section; and
passing the combustion gases from the CMC bridge member into the turbine section.

14. The method of claim 13, wherein, guiding the combustion gases through the CMC bridge member includes diverting the combustion gases away from an end wall portion of the turbine section.

15. The method of claim 13, further comprising: sealing an interface between the CMC bridge member and one of the transition piece and the turbine section to prevent compressor discharge air from entering into a turbine inlet of the turbine section.

16. A turbomachine component comprising:
a ceramic matrix composite (CMC) bridge member configured and disposed to link a transition piece and a turbine section of a turbomachine.

17. The turbomachine component according to claim 16, wherein the CMC bridge member includes an outer surface and an inner surface, the inner surface having a flow guide.

18. The turbomachine component according to claim 16, wherein the CMC bridge member includes a main body having an inlet portion and an outlet portion, the CMC bridge member including a first annular flange extending about the inlet portion and a second annular flange extending about the outlet portion.

19. The turbomachine component according to claim 18, wherein the CMC bridge member includes a mounting element projection radially outward from the body between the first and second flanges.

20. The turbomachine according to claim 16, wherein the CMC bridge member is formed from one of a silicon carbide-silicon carbide (SiC—SiC) composite, oxide-oxide composite, and silicon nitride composite material.
